(19) United States
(12) Patent Application Publication
(10) Pub. No.: US 2008/0063484 A1
(43) Pub. Date: Mar. 13, 2008

(54) Non-step speed changer for a plane shaft of a manual planer

(76) Inventor: Bor-Yann Chuang, Taiping City (TW)

Correspondence Address: BRUCE H. TROXELL, SUITE 1404, 5205 LEESBURG PIKE, FALLS CHURCH, VA, 22041, US

(21) Appl. No.: 11/518,421

(22) Filed: Sep. 11, 2006

(51) Int. Cl. B23D 1/00

(52) U.S. Cl. 409/337; 409/344; 144/129

(57) ABSTRACT

A non-step speed changer for a plane shaft of a manual planer includes an adjust base and a speed-changing cam unit. A motor is fixed on the adjusting base, which can adjust the level of the spindle of the motor. The speed changing cam unit is pivotally connected on the spindle, and a transmitting belt is mounted around the speed changing cam unit and also around the plane shaft of a manual planer. The rotating radius of the transmitting belt around the speed changing cam unit is altered in accordance to lifting up and lowering down of the spindle, so the level of the spindle of the motor is altered, and the planing speed of the plane shaft is altered in the same way, able to enhance the quality of a work finished.

### BACKGROUND OF THE INVENTION

1. Field of the Invention

This invention relates to a manual planer, particularly to one provided with a non-step speed changer, which can adjust the level or position of the spindle of a motor for changing planing speed of the plane shaft of a manual planer.

2. Description of the Prior Art

FIG. 1 shows a conventional manual planer 10, which includes a base 11 and a plane unit 12. A motor 111 is fixed inside the base 11, and a table 112 is mounted on the base 11 for placing a work to be planed thereon. The plane unit 12 is pivotally connected at the center of the table 112, combined with a belt wheel 121 mounted by an endless belt also mounted around the spindle of the motor 111. Then the motor 111 rotates to move the belt around the belt wheel 121, which is then rotated to turn at the same time the plane unit 12 for planing the work placed on the table 112.

However, the motor 111 of the conventional manual planer 10 has only one kind of rotating speed, so the plane unit 12 can carry out planing with a single speed only. Therefore, as different woods have different hardness and densities, needing various speeds to be planed, otherwise the planing work cannot be done efficiently. So the conventional manual planer does not have high effect for planing, impossible to process with high precision to enhance the quality of a work finished.

### SUMMARY OF THE INVENTION

This invention has been devised to offer a non-step speed changer for a plane shaft of a manual planer.

The feature of the non-step speed changer is an adjust base and a speed changing cam unit, and the adjusting base is a flat table, with a motor fixed thereon. The adjust base has one side in parallel to the spindle of the motor, and a connect shaft formed on that side is connected pivotally to the base of the manual planer. The other side of the adjust base can be move up and down, so the adjust base can be swung up and down with the connect shaft functioning as a pivot, and then the level of position of the spindle of the motor is also adjusted together with the motor. The speed changing cam unit is pivotally connected on the spindle, consisting of a cam unit and an elastic member. Further, a transmitting belt is mounted around the spindle in the cam unit, and around the plane shaft of the manual planer. Therefore, the level of the spindle of the motor can be altered by adjusting the location of the adjust base, at the same time the rotating radius of the transmitting belt around the spindle is also altered, and thus the planing speed of the plane shaft may be changed accordingly to suit to the property of a wood work to be planed for obtaining processing accuracy.

### BRIEF DESCRIPTION OF DRAWINGS

This invention will be better understood by referring to the accompanying drawings, wherein:

FIG. 1 is a front view of a conventional manual planer;

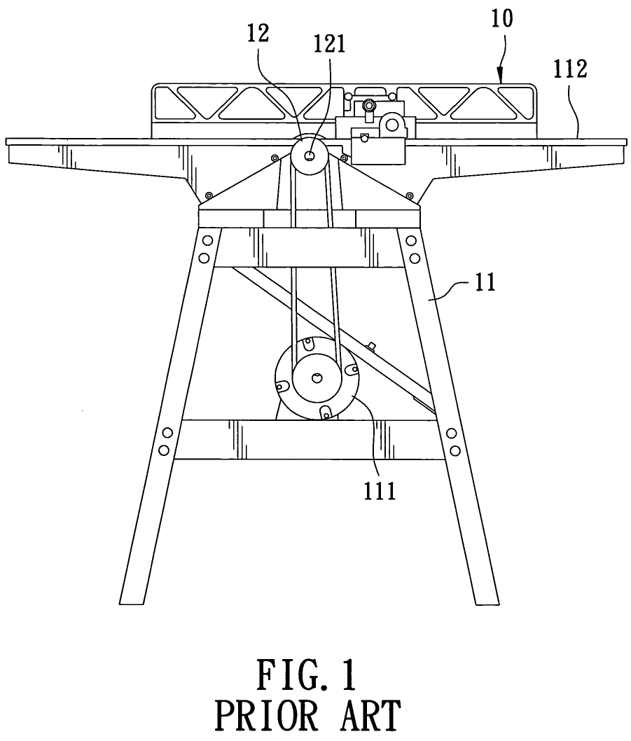

FIG. 2 is a perspective view of a manual planer with a first embodiment of a non-step speed changer for a plane shaft in the present invention;

FIG. 3 is a side view of the manual plane provided with the first embodiment of a non-step speed changer for a plane shaft in the present invention;

FIG. 4 is an exploded perspective view of the first embodiment of a non-step speed changer in the present invention;

FIG. 5 is a side view of the first embodiment of a non-step speed changer under a speed increased in the present invention;

FIG. 6 is a side view of the first embodiment of a non-step speed changer under a speed reduced in the present invention;

FIG. 7 is a side view of a second embodiment of a non-step speed changer under a speed increased in the present invention; and,

FIG. 8 is a side view of the second embodiment of a non-step speed changer under a speed reduced in the present invention.

### DETAILED DESCRIPTION OF THE PREFERRED EMBODIMENTS

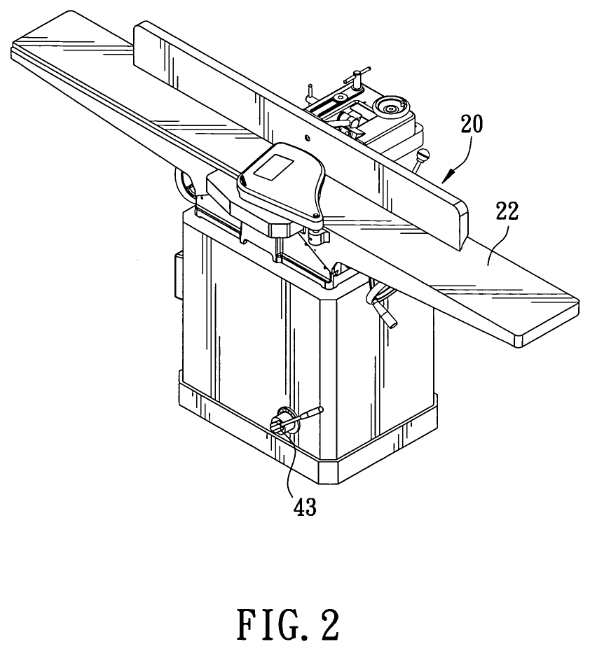

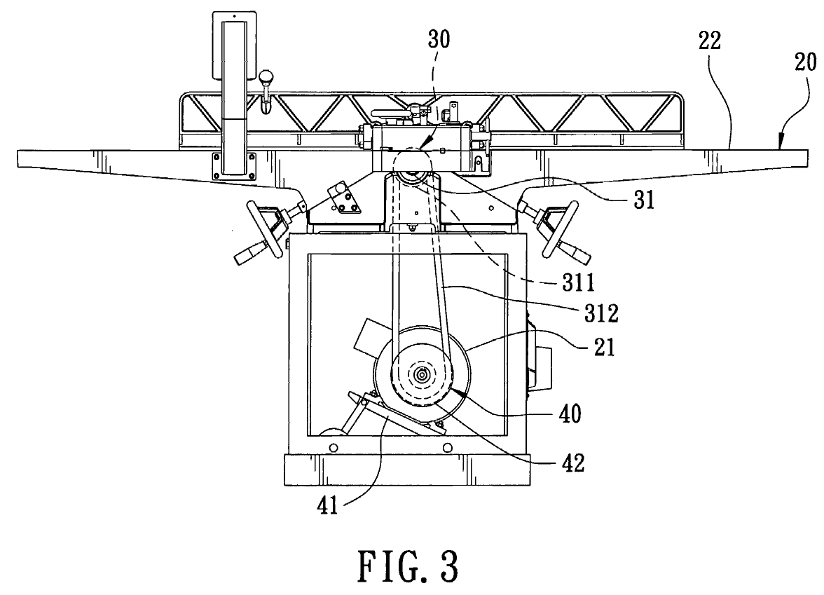

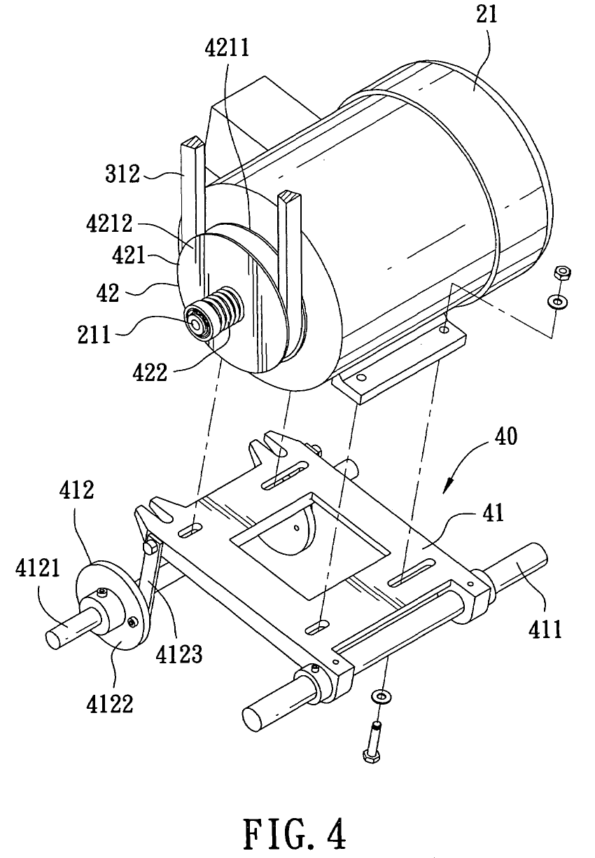

A first embodiment of a non-step speed changer 40 for a plane shaft of a manual planer in the present invention, as shown in FIGS. 2, 3 and 4, is installed in a manual planer, which is provided with a base 20, and a plane shaft unit 30. A motor 21 is fixed in the base 20, having a spindle 211 protruding out of a front end, and a table 22 is fixed on the base 20 for placing a work to be planed. The plane shaft unit 30 is composed of a plane shaft 31 pivotally connected to the table 22, a belt wheel 311 fixed on an end of the plane shaft 31, and a transmitting endless belt 312 is mounted around the belt wheel 311 and also around the spindle 211 in a speed changing cam unit 42, so the planer shaft 31 can be rotated by the transmitting belt 312 via the belt wheel 311 to carry out planing a work placed on the table 22.

The non-step speed changer 40 includes an adjust base 41, a speed changing cam unit 42 and a position device 43. The adjust base 41 is a flat board, and the motor 21 is fixed on the adjust base 41, and a connecting shaft 411 is combined laterally to a first side of the adjust base 41, located in parallel to the spindle 211, and pivotally connected to the base 20. The adjust base 41 further is provided with a adjusting shaft unit 412 connected pivotally to a second side opposite to the first side formed with the connecting shaft 411. The adjust shaft unit 412 has a shaft 4121 pivotally connected in the base 20 and having one end protruding out of the base 20. The two ends of the shaft 4121 are both fixed with a disc 4122 located in the base 20. Further, a connect rod 4123 has a lower end pivotally connected eccentrically on the inner surface of the disc 4122, and an upper end pivotally connected to one of two ends of the second side of the adjust base 41. Then if the disc 4122 of the adjust shaft unit 412 is rotated, the spindle 211 of the motor 21 can be adjusted in its level or position accordingly by movement of the connect rod pushed up or down. The position device 43 is pivotally positioned at an outer side of the shaft 4121, having elastic positioning function on the shaft 4121.

The speed-changing cam unit 42 is composed of a cam unit 421 and an elastic member 422, and the cam unit 312 consists of a first cam 4211 and a second cam 4212. The first and the second cam 4211 and 4212 both have an inner inclined surface gradually swelling up from the outer circumference to the center. The first cam 4211 is pivotally fixed on the spindle 211 and the second cam 4212 is combined movably on the spindle, possible to reciprocate for a axial distance to alter the gap between itself and the first cam 4211. Then a transmitting endless belt 312 is mounted between the first and the second cam 4211 and 4212, or in the cam unit 421, and at the same time an elastic member 422 is fitted around the spindle 211 behind the second cam 4212 to always urge the second cam 4212 so that the second cam 4212 is always pushed elastically by the elastic member 422, forcing the transmitting belt 312 maintained in a definite tension.

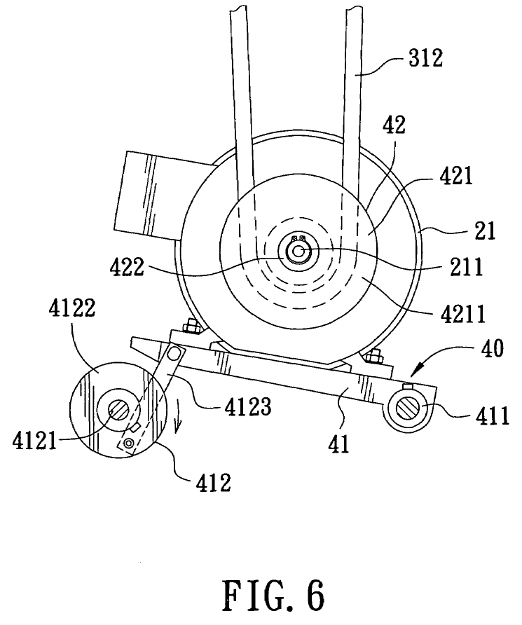

In using, if the rotating speed of he plane shaft 31 is wanted to be lessened, firstly press the position device 43 to let the shaft 4121 to rotate, then the connect rod 4123 is to be rotated eccentrically by the disc 4122 10 and the adjust base 41 together with the motor 21 is to be lowered down. Then the distance between the spindle 211 and the belt wheel 311 is lengthened accordingly so that the transmitting belt 312 moves nearer to the center of the cam unit 421, letting the gap between the second cam 4212 and the first cam 4211 to increase. So the rotating radius of the cam unit 421 may reduce to lower the planing speed of the plane shaft 31, as shown in FIG. 6.

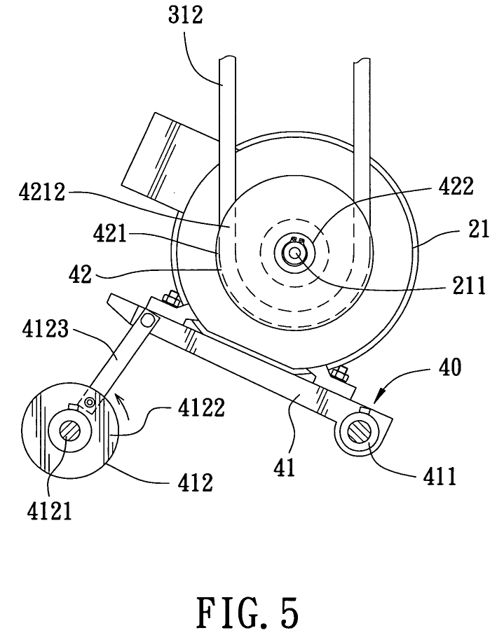

On the contrary, if the plane shaft 31 is needed to increase its rotating speed, the shaft 4121 has to be rotated reversely, letting the disc 4122 rotate the connecting rod 4123 eccentrically, so the connecting rod 4123 may lift up the adjust base 41 to swing up together with the motor 21, with the spindle 211 also raised up accordingly. Then the distance between the spindle 211 and the belt wheel 311 is shortened, so the transmitting belt 312 moved nearer to the outer circumference of the cam unit 421, with the elastic member 422 producing elasticity to press the second cam 4212 toward the first cam 4211. Then the cam unit 421 tightens the transmitting belt 312, which then surely transmits force, increasing the rotating radius of the cam unit 421 for the transmitting belt 312, and then the planing speed of the plane shaft 31 is augmented accordingly, as shown in FIG. 5.

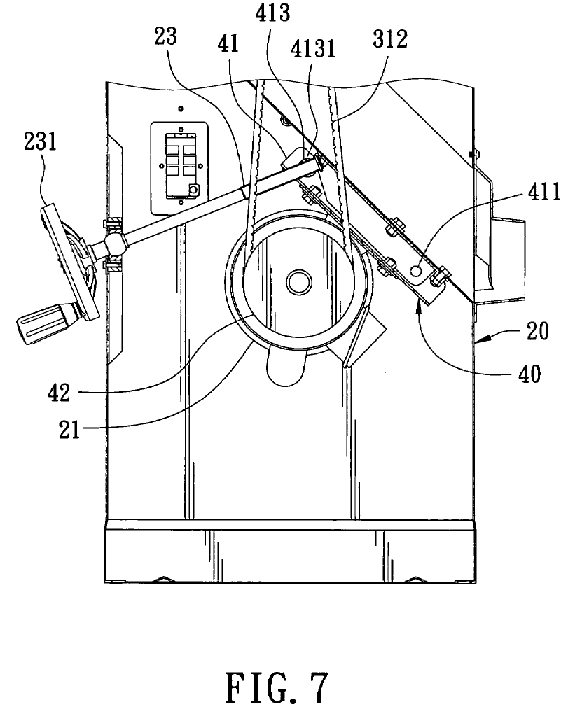

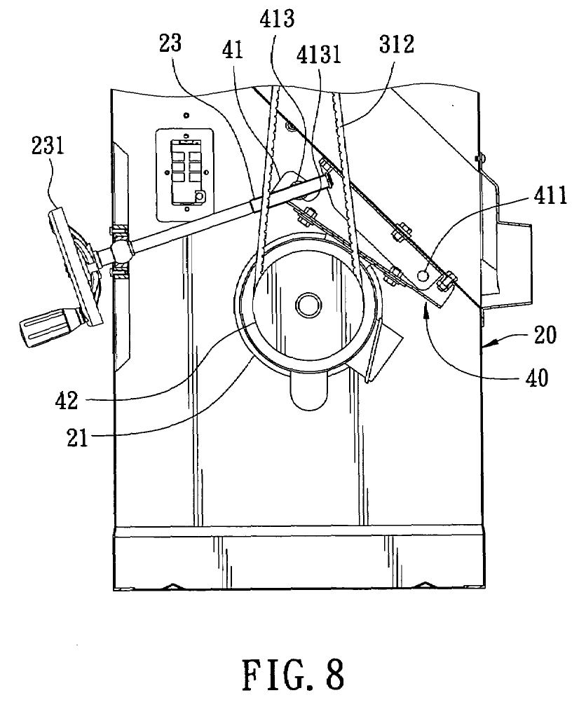

Next, FIGS. 7 and 8 show a second embodiment of a non-step speed changer for a plane shaft of a manual planer in the invention, which has almost the same structure of the first embodiment, except that the adjust base 41 is fixed inclinedly just on the motor 21 and, the adjust base 41 does not have the adjustable shaft unit 412 in the first embodiment, but has a connect rod 413 fixed laterally on the adjust base 41 and a threaded rod 23 having its upper end threadably engaging with a threaded hole 4131 formed in the center of the connect rod 413 and its lower end extending out of the base 20 and fixed with a round handle 231. Then the threaded rod 23 can be rotated by handling the handle 231 to let the adjust base 41 swung up or down for a certain angle by the connect rod 413 moved up or down by rotation of the threaded rod 23, with the connect shaft 411 functioning as a pivot. Then the motor 21 fixed just under the adjust base 41 is also swung up or down for the same angle together with the adjust base 41, permitting the spindle 211 of the motor 21 also altered in its location. Thus, the rotating radial of the transmitting belt 312 around the cam unit 42 is altered, with the speed of the plane shaft 31 also altered accordingly. So the second embodiment has the same function as the first embodiment.

In using the second embodiment, when the planing speed of the plane shaft 31 is needed to be altered, firstly rotate the round handle 231 to let the threaded rod 23 rotate to move the adjust shaft 413 to swing up or down together with the motor 21 so the motor 21 may alter its location and the spindle 211 also altered in its location.

As can be understood from the aforesaid description, the invention has the following advantages.

1. The planing speed of the plane shaft can be altered by changing the position of the motor, permitting the operation easy and accurate to obtain good quality for works finished.

While the preferred embodiments of the inventin have been described above, it will be recognized and understood that various modifications may be made therein and the appended claims are intended to cover all such modifications that may fall within the spirit and scope of the invention.

What is claimed is:

1. A non-step speed changer for a plane shaft of a manual planer, said manual planer having a base and a plane shaft, a motor fixed inside said base, a table fixed on said base, said plane shaft pivotally connected on said table, a belt wheel fixed on one end of said plane shaft, a transmitting endless belt mounted around said belt wheel and also around a spindle of said motor so that said plane shaft is rotated for carrying out planing a work placed on said table, said non-step speed changer comprising:
An adjust base shaped as a flat board and firmly fixed on said motor, said adjust base having a connect shaft formed at its first side and located in parallel to said spindle of said motor, said connect shaft pivotally connected to said base, said adjust base further having a adjust shaft unit pivotally connected with a second side, said adjust shaft unit having a shaft rod with one end pivotally connected to the interior of said base of a manual planer and with the other end extending out of said base, a disc fixed respectively with said two ends of said shaft rod, a connect rod having a lower end eccentrically connected to said disc and an upper end pivotally connected to said second side of said adjust base, said adjust base possible to be swung up or down by rotating said disc with said connect shaft pivotally connected to said base functioning as pivot, said motor with said spindle possible to be swung up or down together with said adjust base so said spindle may be altered in its location;
a cam unit being for changing speed and consisting of a first cam and a second cam said first and said second cam both provided with an inner inclined surface gradually swelling up from their outer circumference to their center, said first cam pivotally fitted on said spindle, said second cam movable fitted on said spindle to reciprocate axially on said spindle to alter an axial length of said cam unit, a transmitting endless belt mounted between said cam unit and altering its rotating radius by alteration of said axial distance of said cam unit, an elastic member fitted around said spindle behind said second cam for elastically always pushing against said second cam.

2. The non-step speed changer for a plane shaft of a manual planer as claimed in claim 1, wherein said adjust base is positioned inclinedly just on said motor, having said second side fixed with a connect rod laterally, said connect rod provided with a threaded hole in its center, a threaded rod provided to be connected pivotally to said base of a manual planer, said threaded rod having an upper end threadably engaging with said threaded hole of said connected rod and a lower end extending out inclinedly out of said base and combined with a round handle, said adjust base together with said motor possible to be swung up or down by rotating said round handle by combination of said threaded rod with said connected rod, accordingly said spindle of said motor possible to be altered in its position.

3. The non-step speed changer for a plane shaft of a manual planer as claimed in claim 1, wherein an elastic member is a spring.
